(19) United States
(12) Patent Application Publication
(10) Pub. No.: US 2026/0146183 A1
(43) Pub. Date: May 28, 2026

(54) SUPRAMOLECULAR HYDROGEL FILM FOR REVERSIBLE ADHESION OF FROZEN FOOD, PRODUCTION METHOD, AND APPLICATION

(71) Applicant: Nanjing Agricultural University, Nanjing (CN)

(72) Inventors: Pei WANG, Nanjing (CN); Zheng FANG, Nanjing (CN); Guangzheng WANG, Nanjing (CN); Runqiang YANG, Nanjing (CN); Dandan LI, Nanjing (CN); Chong XIE, Nanjing (CN)

(73) Assignee: Nanjing Agricultural University, Nanjing (CN)

(21) Appl. No.: 19/177,696

(22) Filed: Apr. 14, 2025

(30) Foreign Application Priority Data
Nov. 27, 2024 (CN) 202411720224.X

(51) Int. Cl. C09J 7/32; A23B 2/80; C08F 285/00

(52) U.S. Cl. CPC C09J 7/32; A23B 2/80; C08F 285/00; C09J 2301/414

(57) ABSTRACT

A supramolecular hydrogel film for reversible adhesion of frozen food, a production method, and an application are provided. The production method includes mixing the arabinoxylan solution with 1-(3-dimethylaminopropyl)-3-ethylcarbodiimide hydrochloride and N-hydroxysuccinimide, and performing an ice bath reaction to obtain the carboxylated arabinoxylan solution; adding dopamine hydrochloride, performing a stirring, dialysis and freeze-drying to obtain the arabinoxylan-dopamine graft; adding acrylic acid and metal ions to the ethanol aqueous solution, mixing with the arabinoxylan-dopamine graft, and performing a stirring, and then mixing with N,N′-methylenebisacrylamide and ammonium persulfate to obtain the supramolecular hydrogel film. The supramolecular hydrogel film has the characteristics of light-controlled reversible adhesion, high mechanical strength, high gas barrier properties and degradability, and is suitable for various frozen foods.

### CROSS REFERENCE TO THE RELATED APPLICATIONS

This application is based upon and claims priority to Chinese Patent Application No. 202411720224.X, filed on Nov. 27, 2024, the entire contents of which are incorporated herein by reference.

### TECHNICAL FIELD

The invention belongs to the technical field of food packaging materials, particularly, a supramolecular hydrogel film for reversible adhesion of frozen food, a production method, and an application.

### BACKGROUND

In the modern food industry, frozen food is gradually favored by consumers because of its convenience, stable quality, and long shelf life. However, in the process of long-term storage in low temperatures, the quality of frozen food will inevitably decline, reasonable packaging can effectively prolong the shelf life of food and reduce food loss, which also requires higher packaging materials. The ideal frozen food packaging should have excellent barrier properties to minimize the impact of oxygen and water vapor on food quality, thereby alleviating the negative effects of ice recrystallization and freeze-burn effects. At the same time, frozen packaging materials should have sufficient mechanical strength to avoid damage during transportation and storage. Although traditional frozen packaging materials can provide a certain degree of protection, these materials often have the disadvantages of easy adhesion to food and difficult to monitor food quality, these shortcomings limit the further development of frozen food. The new intelligent material of light-controlled reversible adhesion hydrogel coating has the characteristics of high mechanical strength, high gas barrier properties, and degradability, and can change its own structure under the light irradiation of a specific wavelength to realize the desorption of packaging, so that consumers can easily open the packaging without residue, it also provides a new way to monitor food quality and safety.

The patent with an application number of CN110734557A discloses a preparation method of pH and temperature dual-responsive cellulose-based hydrogel for food preservation, which uses carboxymethyl cellulose and N-vinylcaprolactam to prepare hydrogel, and then the preservative is loaded on the hydrogel. However, the hydrogel prepared by this technology is not easy to separate from food, which is easy to cause food pollution. The patent with an application number of CN115160570A discloses a preparation method of poly (lipoic acid) material with photo-regulated adhesion performance, where lipoic acid monomer containing azobenzene is prepared by esterification reaction, and a poly (lipoic acid) material containing azobenzene is further obtained by copolymerization. However, this technology has the problems of high production costs, complex processes, and low efficiency.

### SUMMARY

To solve the above technical problems, the invention proposes a supramolecular hydrogel film for reversible adhesion of frozen food, a production method, and an application. The supramolecular hydrogel film produced by the invention has the characteristics of light-controlled reversible adhesion, simple preparation process, high mechanical strength, high gas barrier properties, and degradability, and is suitable for various frozen foods.

To achieve the above purpose, the invention provides a production method for a supramolecular hydrogel film for reversible adhesion of frozen food, including the following steps:
(1) mixing an arabinoxylan solution with 1-(3-dimethylaminopropyl)-3-ethylcarbodiimide hydrochloride and N-hydroxysuccinimide, and performing an ice bath reaction to obtain a carboxylated arabinoxylan solution;
(2) adding dopamine hydrochloride to the carboxylated arabinoxylan solution obtained in step (1), performing a first stirring, dialysis, and freeze-drying to obtain an arabinoxylan-dopamine graft;
(3) adding acrylic acid and metal ions to an ethanol aqueous solution to obtain a mixed system, mixing the mixed system with the arabinoxylan-dopamine graft obtained in step (2), and performing a second stirring to obtain a pre-mixed system, mixing the pre-mixed system with N,N′-methylenebisacrylamide and ammonium persulfate for a polyreaction to obtain a supramolecular hydrogel film.

Preferably, the arabinoxylan solution in step (1) is prepared by dissolving arabinoxylan in water, and the arabinoxylan is extracted from wheat bran.

Preferably, a mass concentration of the arabinoxylan solution described in step (1) is 1%-2%; the arabinoxylan solution described in step (1) is mixed with 1-(3-dimethylaminopropyl)-3-ethylcarbodiimide hydrochloride and N-hydroxysuccinimide at a molar ratio of 1:(1-2.5):(1-2.5).

Preferably, a temperature of the ice bath reaction in step (1) is 0° C., and a time of the ice bath reaction is 0.5-2 h.

Preferably, the dopamine hydrochloride is added to the carboxylated arabinoxylan solution described in step (2) to a mass concentration of 0.05%-0.2%; a temperature of the first stirring in step (2) is 15-25° C., and a time of the first stirring in step (2) is 12-24 h; the dialysis described in step (2) is performed in water, and a dialysis time is 72 h; a freeze-drying temperature in step (2) is −80° C., and a freeze-drying time is 48 h.

Preferably, a volume concentration of the ethanol aqueous solution described in step (3) is 60%-80%, acrylic acid is added to the ethanol aqueous solution described in step (3) to a final mass concentration of 0.2%-0.4%, and metal ions are added to a final mass concentration of 0.3%-0.5%.

Preferably, a mass ratio of the mixed system described in step (3) to the arabinoxylan-dopamine graft obtained in step (2) is (97-99):(1-3); a temperature of the second stirring in step (3) is 40-60° C., a speed of the second stirring is 150-250 rpm, and a time of the second stirring is 40-60 min.

Preferably, a mass ratio of the pre-mixed system in step (3) with N,N′-methylenebisacrylamide, and ammonium persulfate is (99.3-99.75):(0.2-0.5):(0.05-0.2), a temperature of the polyreaction in step (3) is 70-90° C., and a time of the polyreaction is 30-60 min.

The invention also provides a supramolecular hydrogel film prepared by the production method.

The invention also provides an application of the supramolecular hydrogel film prepared by the production method in frozen food packaging.

Compared with the prior art, the invention has the following advantages and technical effects:
The invention uses wheat bran as raw material to extract arabinoxylan (AX), carboxylation modification, and dopamine grafting to obtain the modified AX; through metal ion coordination and acrylic acid crosslinking, the light-controlled reversible adhesion of supramolecular hydrogel is realized, and a supramolecular hydrogel film for frozen food is prepared. AX, which is rich in wheat bran, is a degradable polysaccharide with good application prospects, it has the advantages of high yield and low cost. AX has good surface adhesion after dopamine grafting, and can be closely adsorbed on the surface of the target material through non-covalent interaction. The carboxyl group of the AX-dopamine graft can coordinate with the metal ions, and the Fenton-like reaction will occur under ultraviolet light irradiation, which will cause the valence state of the metal ions to change, resulting in the fracture of the coordination bond, which will lead to the reconstruction of the supramolecular network, making the hydrogel film adhesion behavior change.

Using dopamine grafting, metal ion chelation, and other methods, the invention realizes light-controlled reversible adhesion and is easy to separate from food. By grafting carboxylated AX with dopamine, the mechanical strength and barrier properties of hydrogels at low temperatures are improved by metal ion coordination and oxidative crosslinking of acrylic acid. Through the coordination of metal ions, the valence state of metal ions is changed and the coordination compounds are dissociated under ultraviolet light irradiation, to realize the reconstruction of the supramolecular network and light-regulated desorption.

### DETAILED DESCRIPTION OF THE EMBODIMENTS

A variety of exemplary embodiments of the invention are described in detail, which should not be considered a limitation to the invention, but should be understood as a more detailed description of certain aspects, characteristics, and embodiments of the invention.

It should be understood that the terms described in the invention are only used to describe a particular embodiment and are not intended to constrain the invention. In addition, for the numerical range in the invention, it should be understood that each intermediate value between the upper and lower limits of the range is also specifically disclosed. Each smaller range between any stated value or intermediate value within the stated range and any other stated value or intermediate value within the stated range is also included in the invention. The upper and lower limits of these smaller ranges can be included or excluded independently.

Unless otherwise stated, all technical and scientific terms used in this paper have the same meaning that conventional technicians in the described field usually understand. Although the present invention describes only preferred methods and materials, any methods and materials similar or equivalent to those described herein may be used in the implementation or testing of the present invention. All references mentioned in this instruction are incorporated by reference to disclose and describe the methods and/or materials associated with the reference. In case of conflict with any incorporated literature, the contents of this instruction shall prevail.

Without deviating from the scope or spirit of the invention, a variety of improvements and changes can be made to the specific embodiment of the specification of the invention, which is obvious to the technicians in this field. Other embodiments obtained from the instructions of the invention are obvious to technicians. The instructions and embodiments of the invention are only illustrative.

The words “contain, include, have, comprise”, and so on used in this paper are all open terms, which means contain but not limited to.

### Embodiment 1

Arabinoxylan is obtained from wheat bran by conventional methods, including starch removal, alkali extraction, deproteinization, enzyme treatment, dialysis, and ethanol precipitation.
(1) Arabinoxylan is dissolved in water to prepare the arabinoxylan solution with a mass concentration of 2%, the arabinoxylan solution is mixed with 1-(3-dimethylaminopropyl)-3-ethylcarbodiimide hydrochloride and N-hydroxysuccinimide in a molar ratio of 1:1.5:1.5, and the ice bath reaction is performed at 0° C. for 0.5 h to obtain the carboxylated arabinoxylan solution.
(2) The arabinoxylan-dopamine graft is obtained by adding dopamine hydrochloride to the carboxylated arabinoxylan solution to its mass concentration of 0.1%, the first stirring is performed at 20° C. for 24 h, dialysis is performed in water for 72 h, and freeze-drying is performed at −80° C. for 48 h, the arabinoxylan-dopamine graft is obtained.
(3) Acrylic acid and metal ions are added to the ethanol aqueous solution with a volume concentration of 60%, acrylic acid is added to its final mass concentration of 0.4%, and metal ions are added to its final mass concentration of 0.4% to obtain a mixed system, the mixed system is mixed with the arabinoxylan-dopamine graft at a mass ratio of 98:2, and the second stirring is performed at 50° C. and 200 rpm for 50 min to obtain a pre-mixed system; the pre-mixed system is mixed with N,N′-methylenebisacrylamide and ammonium persulfate at a mass ratio of 99.55:0.3:0.15, and polyreaction is performed at 80° C. for 50 min to obtain a supramolecular hydrogel film.

The adhesion strength of the hydrogel film is measured by a micro-tensile testing machine equipped with a fixture. Before the test, all the samples are cut into rectangular strips (50×15mm) and attached to the substrate to ensure no bubbles and impurities. The sample is fixed on the fixture of the micro tensile testing machine, and the test speed is set to 100 mm/min, and the test is repeated 5 times.

The tensile strength of the hydrogel film is measured by an automatic tensile texture analyzer equipped with a tensile fixture. Before the test, all the samples are cut into rectangular strips (50×15 mm), the test speed is 60 mm/min, the initial distance is 40 mm, and the test is repeated 5 times, the thickness of the film is measured by a vernier caliper, and the average value is randomly measured at 6 positions.

The adhesion strength of the prepared supramolecular hydrogel film can reach more than 500 kPa, the tensile strength can reach 54.74 kPa, and the desorption can be achieved by UV irradiation at a wavelength of 365 nm for 180 s.

### Embodiment 2

Arabinoxylan is obtained from wheat bran by conventional methods, including starch removal, alkali extraction, deproteinization, enzyme treatment, dialysis, and ethanol precipitation.
(1) Arabinoxylan is dissolved in water to prepare the arabinoxylan solution with a mass concentration of 2%, the arabinoxylan solution is mixed with 1-(3-dimethylaminopropyl)-3-ethylcarbodiimide hydrochloride and N-hydroxysuccinimide in a molar ratio of 1:1:1, and the ice bath reaction is performed at 0° C. for 0.5 h to obtain the carboxylated arabinoxylan solution.
(2) The arabinoxylan-dopamine graft is obtained by adding dopamine hydrochloride to the carboxylated arabinoxylan solution to its mass concentration of 0.05%, the first stirring is performed at 20° C. for 24 h, dialysis is performed in water for 72 h, and freeze-drying is performed at −80° C. for 48 h, the arabinoxylan-dopamine graft is obtained.
(3) Acrylic acid and metal ions are added to the ethanol aqueous solution with a volume concentration of 70%, acrylic acid is added to its final mass concentration of 0.2%, and metal ions are added to its final mass concentration of 0.3% to obtain a mixed system, the mixed system is mixed with the arabinoxylan-dopamine graft at a mass ratio of 99:1, and the second stirring is performed at 50° C. and 200 rpm for 50 min to obtain a pre-mixed system; the pre-mixed system is mixed with N,N′-methylenebisacrylamide and ammonium persulfate at a mass ratio of 99.75:0.2:0.05, and polyreaction is performed at 80° C. for 50 min to obtain a supramolecular hydrogel film.

The adhesion strength of the hydrogel film is measured by the micro-tensile testing machine equipped with a fixture. Before the test, all the samples are cut into rectangular strips (50×15 mm) and attached to the substrate to ensure no bubbles and impurities. The sample is fixed on the fixture of the micro tensile testing machine, and the test speed is set to 100 mm/min, and the test is repeated 5 times.

The tensile strength of the hydrogel film is measured by an automatic tensile texture analyzer equipped with a tensile fixture. Before the test, all the samples are cut into rectangular strips (50×15 mm), the test speed is 60 mm/min, the initial distance is 40 mm, and the test is repeated 5 times, the thickness of the film is measured by a vernier caliper, and the average value is randomly measured at 6 positions.

The adhesion strength of the prepared supramolecular hydrogel film can reach more than 430 kPa, the tensile strength can reach 47.33 kPa, and the desorption can be achieved by UV irradiation at a wavelength of 365 nm for 210 s.

### Embodiment 3

Arabinoxylan is obtained from wheat bran by conventional methods, including starch removal, alkali extraction, deproteinization, enzyme treatment, dialysis, and ethanol precipitation.
(1) Arabinoxylan is dissolved in water to prepare the arabinoxylan solution with a mass concentration of 2%, the arabinoxylan solution is mixed with 1-(3-dimethylaminopropyl)-3-ethylcarbodiimide hydrochloride and N-hydroxysuccinimide in a molar ratio of 1:2.5:2.5, and the ice bath reaction is performed at 0° C. for 0.5 h to obtain the carboxylated arabinoxylan solution.
(2) The arabinoxylan-dopamine graft is obtained by adding dopamine hydrochloride to the carboxylated arabinoxylan solution to its mass concentration of 0.2%, the first stirring is performed at 20° C. for 24 h, dialysis is performed in water for 72 h, and freeze-drying is performed at −80° C. for 48 h, the arabinoxylan-dopamine graft is obtained.
(3) Acrylic acid and metal ions are added to the ethanol aqueous solution with a volume concentration of 70%, acrylic acid is added to its final mass concentration of 0.4%, and metal ions are added to its final mass concentration of 0.5% to obtain a mixed system, the mixed system is mixed with the arabinoxylan-dopamine graft at a mass ratio of 97:3, and the second stirring is performed at 50° C. and 200 rpm for 50 min to obtain a pre-mixed system; the pre-mixed system is mixed with N,N′-methylenebisacrylamide and ammonium persulfate at a mass ratio of 99.3:0.5:0.2, and polyreaction is performed at 80° C. for 50 min to obtain a supramolecular hydrogel film.

The adhesion strength of the hydrogel film is measured by the micro-tensile testing machine equipped with a fixture. Before the test, all the samples are cut into rectangular strips (50×15 mm) and attached to the substrate to ensure no bubbles and impurities. The sample is fixed on the fixture of the micro tensile testing machine, and the test speed is set to 100 mm/min, and the test is repeated 5 times.

The tensile strength of the hydrogel film is measured by an automatic tensile texture analyzer equipped with a tensile fixture. Before the test, all the samples are cut into rectangular strips (50×15 mm), the test speed is 60 mm/min, the initial distance is 40 mm, and the test is repeated 5 times, the thickness of the film is measured by a vernier caliper, and the average value is randomly measured at 6 positions.

The adhesion strength of the prepared supramolecular hydrogel film can reach more than 470 kPa, the tensile strength can reach 51.29 kPa, and the desorption can be achieved by UV irradiation at a wavelength of 365 nm for 195 s.

The above-mentioned embodiments only describe the preferred method of the invention, they are not used to limit the scope of the invention. Under the premise of not deviating from the design spirit of the invention, various deformations and improvements made by ordinary technicians in this field to the technical scheme of the invention should fall within the scope of protection determined by the claims of the invention.

What is claimed is:

1. A production method for a supramolecular hydrogel film for reversible adhesion of frozen food, comprising the following steps:
(1) mixing an arabinoxylan solution with 1-(3-dimethylaminopropyl)-3-ethylcarbodiimide hydrochloride and N-hydroxysuccinimide, and performing an ice bath reaction to obtain a carboxylated arabinoxylan solution;
(2) adding dopamine hydrochloride to the carboxylated arabinoxylan solution obtained in step (1), performing a first stirring, dialysis, and freeze-drying to obtain an arabinoxylan-dopamine graft;
(3) adding acrylic acid and metal ions to an ethanol aqueous solution to obtain a mixed system, mixing the mixed system with the arabinoxylan-dopamine graft obtained in step (2), and performing a second stirring to obtain a pre-mixed system, mixing the pre-mixed system with N,N′-methylenebisacrylamide and ammonium persulfate for a polyreaction to obtain the supramolecular hydrogel film.

2. The production method according to claim 1, wherein the arabinoxylan solution in step (1) is prepared by dissolving arabinoxylan in water, and the arabinoxylan is extracted from wheat bran.

3. The production method according to claim 1, wherein a mass concentration of the arabinoxylan solution in step (1) is 1%-2%; the arabinoxylan solution in step (1) is mixed with the 1-(3-dimethylaminopropyl)-3-ethylcarbodiimide hydrochloride and the N-hydroxysuccinimide at a molar ratio of 1:(1-2.5):(1-2.5).

4. The production method according to claim 1, wherein a temperature of the ice bath reaction in step (1) is 0° C., and a time of the ice bath reaction is 0.5-2 h.

5. The production method according to claim 1, wherein the dopamine hydrochloride is added to the carboxylated arabinoxylan solution in step (2) to a mass concentration of 0.05%-0.2%; a temperature of the first stirring in step (2) is 15-25° C., and a time of the first stirring in step (2) is 12-24 h; the dialysis in step (2) is performed in water, and a dialysis time is 72 h; a freeze-drying temperature in step (2) is −80° C., and a freeze-drying time is 48 h.

6. The production method according to claim 1, wherein a volume concentration of the ethanol aqueous solution in step (3) is 60%-80%, the acrylic acid is added to the ethanol aqueous solution in step (3) to a final mass concentration of 0.2%-0.4%, and the metal ions are added to a final mass concentration of 0.3%-0.5%.

7. The production method according to claim 1, wherein a mass ratio of the mixed system in step (3) to the arabinoxylan-dopamine graft obtained in step (2) is (97-99):(1-3); a temperature of the second stirring in step (3) is 40-60° C., a speed of the second stirring is 150-250 rpm, and a time of the second stirring is 40-60 min.

8. The production method according to claim 1, wherein a mass ratio of the pre-mixed system in step (3) with the N,N′-methylenebisacrylamide and the ammonium persulfate is (99.3-99.75):(0.2-0.5):(0.05-0.2), a temperature of the polyreaction in step (3) is 70-90° C., and a time of the polyreaction is 30-60 min.

9. A supramolecular hydrogel film prepared by the production method according to claim 1.

10. A method for frozen food packaging, comprising using the supramolecular hydrogel film prepared by the production method according to claim 1.

11. The supramolecular hydrogel film according to claim 9, wherein in the production method, the arabinoxylan solution in step (1) is prepared by dissolving arabinoxylan in water, and the arabinoxylan is extracted from wheat bran.

12. The supramolecular hydrogel film according to claim 9, wherein in the production method, a mass concentration of the arabinoxylan solution in step (1) is 1%-2%;
the arabinoxylan solution in step (1) is mixed with the 1-(3-dimethylaminopropyl)-3-ethylcarbodiimide hydrochloride and the N-hydroxysuccinimide at a molar ratio of 1:(1-2.5):(1-2.5).

13. The supramolecular hydrogel film according to claim 9, wherein in the production method, a temperature of the ice bath reaction in step (1) is 0° C., and a time of the ice bath reaction is 0.5-2 h.

14. The supramolecular hydrogel film according to claim 9, wherein in the production method, the dopamine hydrochloride is added to the carboxylated arabinoxylan solution in step (2) to a mass concentration of 0.05%-0.2%; a temperature of the first stirring in step (2) is 15-25° C., and a time of the first stirring in step (2) is 12-24 h; the dialysis in step (2) is performed in water, and a dialysis time is 72 h; a freeze-drying temperature in step (2) is −80° C., and a freeze-drying time is 48 h.

15. The supramolecular hydrogel film according to claim 9, wherein in the production method, a volume concentration of the ethanol aqueous solution in step (3) is 60%-80%, the acrylic acid is added to the ethanol aqueous solution in step (3) to a final mass concentration of 0.2%-0.4%, and the metal ions are added to a final mass concentration of 0.3%-0.5%.

16. The supramolecular hydrogel film according to claim 9, wherein in the production method, a mass ratio of the mixed system in step (3) to the arabinoxylan-dopamine graft obtained in step (2) is (97-99):(1-3); a temperature of the second stirring in step (3) is 40-60° C., a speed of the second stirring is 150-250 rpm, and a time of the second stirring is 40-60 min.

17. The supramolecular hydrogel film according to claim 9, wherein in the production method, a mass ratio of the pre-mixed system in step (3) with the N,N′-methylenebisacrylamide and the ammonium persulfate is (99.3-99.75):(0.2-0.5):(0.05-0.2), a temperature of the polyreaction in step (3) is 70-90° C., and a time of the polyreaction is 30-60 min.

18. The method according to claim 10, wherein in the production method, the arabinoxylan solution in step (1) is prepared by dissolving arabinoxylan in water, and the arabinoxylan is extracted from wheat bran.

19. The method according to claim 10, wherein in the production method, a mass concentration of the arabinoxylan solution in step (1) is 1%-2%; the arabinoxylan solution in step (1) is mixed with the 1-(3-dimethylaminopropyl)-3-ethylcarbodiimide hydrochloride and the N-hydroxysuccinimide at a molar ratio of 1:(1-2.5):(1-2.5).

20. The method according to claim 10, wherein in the production method, a temperature of the ice bath reaction in step (1) is 0° C., and a time of the ice bath reaction is 0.5-2 h.
